(19) United States
(12) Patent Application Publication
(10) Pub. No.: US 2014/0354748 A1
(43) Pub. Date: Dec. 4, 2014

(54) Processes for Printing on Heat Shield Product

(71) Applicant: Jason Pope, Brighton, TN (US)

(72) Inventor: Jason Pope, Brighton, TN (US)

(21) Appl. No.: 13/905,182

(22) Filed: May 30, 2013

(51) Int. Cl. B41J 11/02

(52) U.S. Cl. CPC B41J 11/02
USPC 347/110

(57) ABSTRACT

A process of printing directly onto heat shield product using a method of feeding the heat shield product into a digital printer modified to print on heat shield product or a mechanical printer modified to print on heat shield product, the digital printer being controlled by a computer using a computer program designed for graphics or the mechanical printer being set up to print a graphic on the heat shield product, and a drying system such as heat lamps or air drying to dry the ink and assist in adhering the ink to the heat shield product.

### CROSS-REFERENCE TO RELATED APPLICATIONS

| | | |
|---|---|---|
| 2004/0252173 | December 2004 | Ben-Zur et al. |
| 8,205,981 | June 2012 | Marino et al. |

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISC

Not Applicable

### DESCRIPTION

### Field of the Invention

This invention relates to the process of printing on heat shield product. There is no current state of the art for printing on heat shield product. The nearest digital equivalent is to use a digital printer to print on textiles, which are then heated or air dried in order to ensure that the ink or dye adheres to and sets up on the material. The nearest machine printing equivalent is to use rollers, cylinders or some other type of machine to print on textiles, where after the printing process the textile is heated or air dried to allow the ink or dye to adhere to the textile. The present disclosure modifies the existing state of the art of printing on textiles to allow an individual to print pattern or designs on heat shield product.

### BACKGROUND OF THE INVENTION

There is no current state of the art in printing on heat shield product. The nearest equivalent is to print on textile by inserting the textile into the printer so that the image can be printed, removed from the printer, and then thermally treated, usually through pressing, or air dried. The nearest machine printing equivalent is to use rollers, cylinders or some other type of machine to print on textiles, where after the printing process the textile is then heated or air dried to allow the dye or ink to adhere to the textile. The intent of the present disclosure is to modify the process of printing on textiles for the application of printing on heat shield product.

In U.S. Pat. No. 8,205,981, Marino et al discloses a direct to only a garment printer whereas the present disclosure teaches the process for printing on extended lengths of heat shield product.

In U.S. Patent Application 2004/0252173, Ben-Zur et al. discloses the process of printing on a layer and then applying the layer onto a textile, whereas the present disclosure teaches the process for using a digital printer to print on extended lengths of heat shield product.

### SUMMARY OF THE INVENTION

Processes for printing on heat shield product.

### BRIEF DESCRIPTION OF THE SEVERAL VIEWS OF THE DRAWING

FIG. 1 is a display of a digital printer with a platen and rollers so that heat shield product can be laid out, attached to the platen, fed into the digital printer and from the digital printer into the drying process;

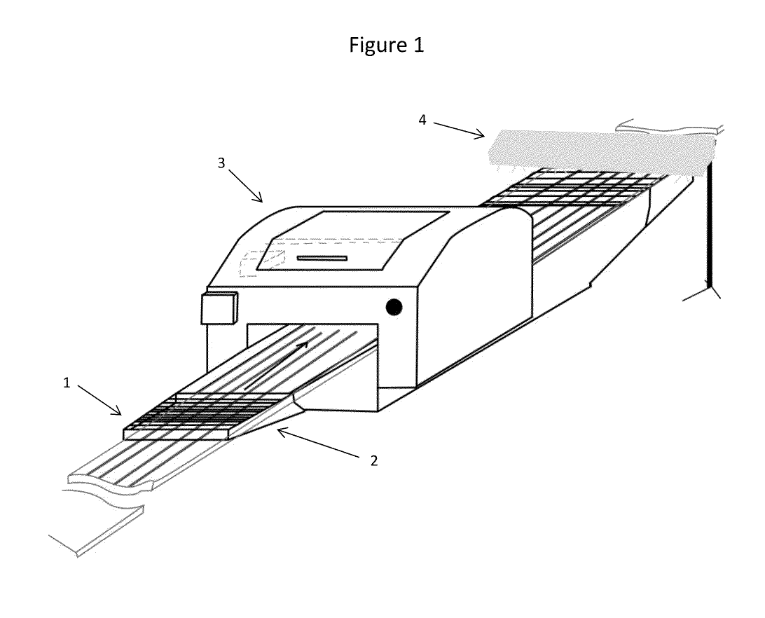

FIG. 2 is a display of a digital printer with a rack system upon which is placed rolls of heat shield product, the heat shield product is then fed from the rollers into the digital printer and from the digital printer into the drying process;

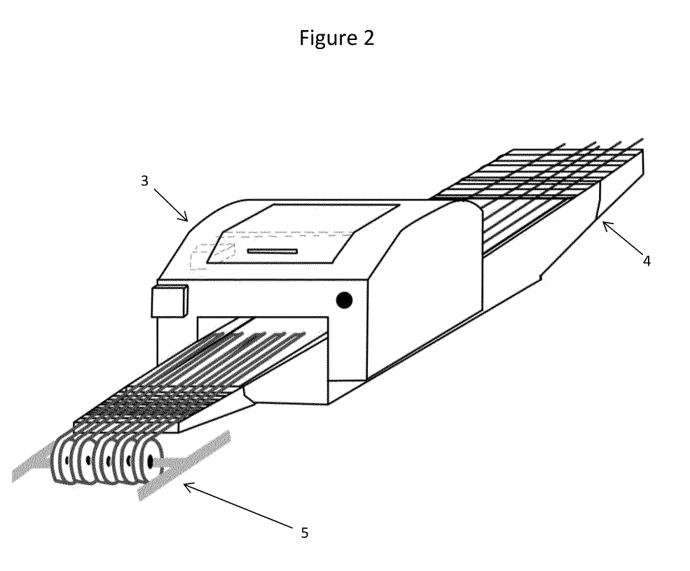

FIG. 3 is a display of a digital printer with a platen and rollers so that heat shield product can be laid out, attached to the platen, fed into the machine printer and from the machine printer into the drying process; and

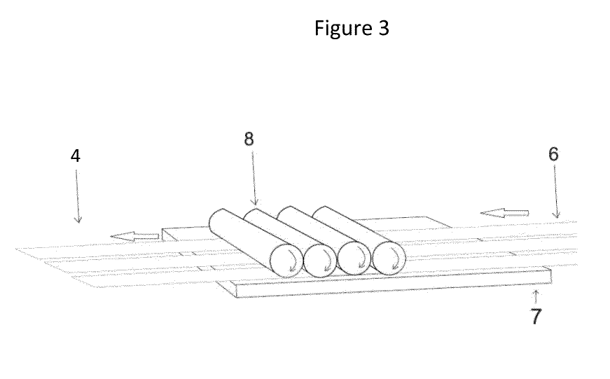

FIG. 4 is a display of a machine printer with a rack system upon which is placed rolls of heat shield product, the heat shield product is then fed from the rollers into the machine printer and from the machine printer into the drying process.

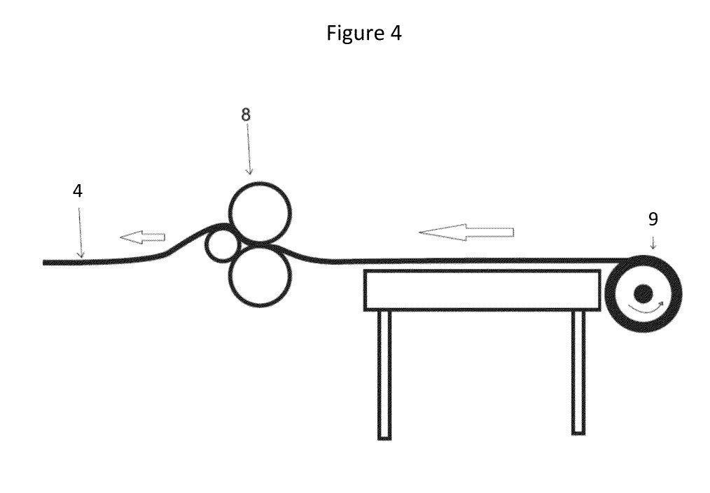

### DETAILED DESCRIPTION OF THE INVENTION

A process for printing on heat shield product, including but not limited to woven or formed ceramic fiber material, fiberglass material, titanium lava rock material, basalt material or any material used for a high heat shield wrap on headers, exhaust pipes, wood stoves or any other high heat pipes, where the first preferred embodiment comprising an extended platen 1 to affix the heat shield product to during printing, additional rollers 2 upon which the platen with the heat shield product is laid out to be fed into a digital printer 3 set up for printing on heat shield product, where the image is printed onto the heat shield product, and then fed into a drying system 4 that includes heat lamps or similar apparatus, or allowing the heat shield product to air dry, for the purpose of drying and adhering the image onto the heat shield product. The system is controlled by a computer using a program designed for graphics.

A second preferred embodiment includes a rack system 5 upon which rolls of heat shield product are placed, where the rack system allows the rolls to be easily or mechanically rotated, so that the heat shield product can then be fed into a digital printer 3 set up for printing on heat shield product, where the image is printed onto the heat shield product, followed by a drying system 4 that includes heat lamps or similar apparatus, or allowing the heat shield product to air dry, for the purpose of drying and adhering the image onto the heat shield product. The system is controlled by a computer using a program designed for graphics.

A third preferred embodiment comprising an extended platen 6 to affix the heat shield product to during printing, additional rollers 7 upon which the platen with the heat shield product is laid out to be fed into a machine printer 8 set up for printing on heat shield product, where the machine printer includes but is not limited to the process of using rollers, cylinders or screening process, where the image is printed onto the heat shield product, and then fed into a drying system 4 that includes heat lamps or similar apparatus, or allowing the heat shield product to air dry, for the purpose of drying and adhering the image onto the heat shield product.

A fourth preferred embodiment includes a rack system 9 upon which rolls of heat shield product are placed, where the rack system allows the rolls to be easily or mechanically rotated, so that the heat shield product can then be fed into a machine printer 8 set up for printing on heat shield product, where the image is printed onto the heat shield product, followed by a drying system 4 that includes heat lamps or similar apparatus, or allowing the heat shield product to air dry, for the purpose of drying and adhering the image onto the heat shield product.

What is claimed:

1. A process for digitally printing heat shield product, comprising a platen and rollers upon which the platen with the attached heat shield product is laid out to be fed into a digital printer;
where the design of the image is configured and communicated to the digital printer with the use of a computer program designed for graphics;
where the digital printer is modified to print on heat shield product and imprints an image onto the length of the heat shield product; and
where the platen and heat shield product exits the digital printer and is fed into a drying system for the purpose of drying and adhering the image onto the heat shield product.

2. The process for digital printing on extended lengths of heat shield product of claim 1 where the drying system is made up of a series of heat lamps.

3. The process for digital printing on extended lengths of heat shield product of claim 1 where the drying system is made up of allowing the heat shield product to air dry.

4. The process for digital printing on extended lengths of heat shield product of claim 1 where the digital printer is an industrial version of the digital printer.

5. The process for digital printing on extended lengths of heat shield product of claim 4 where the drying system is made up of a series of heat lamps.

6. The process for digital printing on extended lengths of heat shield product of claim 4 where the drying system is made up of allowing the heat shield product to air dry.

7. The process for digital printing on extended lengths of heat shield product of claim 1, 2, 3, 4, 5, or 6 where the computer also controls the feeder system into the digital printer and from the digital printer to the drying system.

8. A process for digital printing on heat shield product, comprising rack upon which rolls of heat shield product can be placed, where the rolls of heat shield product are able to be rotated so that the heat shield product is fed into an digital printer;
where the design of the image is configured and communicated to the digital printer with the use of a computer program designed for graphics;
where the digital printer is modified to print on heat shield product and imprints the image onto the heat shield product; and
where the heat shield product exits the digital printer and is fed into a drying system for the purpose of drying and adhering the image onto the heat shield product.

9. The process for digital printing on extended lengths of heat shield product of claim 8 where the drying system is made up of a series of heat lamps.

10. The process for digital printing on extended lengths of heat shield product of claim 8 where the drying system is made up of allowing the heat shield product to air dry.

11. The process for digital printing on heat shield product of claim 8 where the digital printer is an industrial version of the digital printer.

12. The process for digital printing on extended lengths of heat shield product of claim 11 where the drying system is made up of a series of heat lamps.

13. The process for digital printing on extended lengths of heat shield product of claim 7 where the drying system is made up of allowing the heat shield product to air dry.

14. The process for digital printing on extended lengths of heat shield product of claim 8, 9, 10, 11, 12, or 13 where the computer also controls the feeder system into the digital printer and from the digital printer to the drying system.

15. A process for machine printing heat shield product, comprising a platen and rollers upon which the platen with the attached heat shield product is laid out to be fed into a machine printer;
where the design of the image is configured and set up on a machine printer;
where the machine printer is modified to print on heat shield product and imprints an image onto the heat shield product; and
where the platen and heat shield product exits the machine printer and is fed into a drying system for the purpose of drying and adhering the image onto the heat shield product.

16. The process for machine printing on heat shield product of claim 15 where the drying system is made up of a series of heat lamps.

17. The process for machine printing on heat shield product of claim 15 where the drying system is made up allowing the heat shield product to air dry.

18. The process for machine printing on heat shield product of claim 15 where the machine printer is an industrial version of the machine printer.

19. The process for machine printing on heat shield product of claim 18 where the drying system is made up of allowing the heat shield product to air dry.

20. The process for machine printing on heat shield product of claim 18 where the drying system is made up of a series of heat lamps.

21. The process for machine printing on heat shield product of claim 15, 16, 17, 18, 19, or 20 where the feeder system is mechanically to feed the heat shield product into the machine printer and from the machine printer to the drying system.

22. A process for machine printing on heat shield product, comprising rack upon which rolls of heat shield product can be placed, where the rolls of heat shield product are able to be rotated so that the heat shield product is fed into a machine printer;
where the design of the image is configured and set up on the machine printer;
where the machine printer is modified to print on heat shield product and imprints an image onto the heat shield product; and
where the heat shield product exits the machine printer and is fed into a drying system for the purpose of drying and adhering the image onto the heat shield product.

23. The process for machine printing on extended lengths of heat shield product of claim 22 where the drying system is made up of a series of heat lamps.

24. The process for machine printing on extended lengths of heat shield product of claim 22 where the drying system is made up of allowing the heat shield product to air dry.

25. The process for machine printing on extended lengths of heat shield product of claim 22 where the digital printer is an industrial version of the machine printer.

26. The process for machine printing on extended lengths of heat shield product of claim 25 where the drying system is made up of a series of heat lamps.

27. The process for machine printing on heat shield product of claim 25 where the drying system is made up allowing the heat shield product to air dry.

28. The process for machine printing on heat shield product of claim 22, 23, 24, 25, 26, or 27 where the feeder system is mechanically controlled to feed the heat shield product into the machine printer and from the machine printer to the drying system.
